(19) United States
(12) Patent Application Publication
(10) Pub. No.: US 2017/0007011 A1
(43) Pub. Date: Jan. 12, 2017

(54) Protective Case for Electronic Camcorders for Air, Land and Underwater Use Employing User Securements

(71) Applicant: Larry Tang, East Brunswick, NJ (US)

(72) Inventor: Larry Tang, East Brunswick, NJ (US)

(21) Appl. No.: 15/202,625

(22) Filed: Jul. 6, 2016

Related U.S. Application Data
(60) Provisional application No. 62/188,800, filed on Jul. 6, 2015.

(51) Int. Cl. A45F 5/00; G03B 17/56

(52) U.S. Cl. CPC A45F 5/00; G03B 17/561; A45F 2005/006

(57) ABSTRACT

A protective case for electronic camera/camcorders for air, land and underwater use including manners of securing the protective case about the neck area of a user and/or about the body of the user as well.

### CROSS-REFERENCE TO RELATED APPLICATIONS

A Provisional Patent Application covering the invention described herein was filed on Jul. 6, 2015, and assigned Ser. No. 62/188,800.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

Field of the Invention

This invention relates to electric camcorders, in general, and to those employing protective cases for air, land and underwater use, in particular.

Description of the Related Art

As has been described, if people wanted footage of themselves engaged in physical activities, until fairly recently, they needed another person to hold and operate an electronic camera for them. Furthermore, the camera operator needed to be skilled in order to obtain compelling content. Additionally, capturing high-quality content often required expensive, fragile and cumbersome camera equipment that was not accessible to everyone. Accordingly, it was not often practical for people to document their experiences during their lives' most enjoyable moments.

In order to accommodate photography during such physical activities as skating, skiing, hiking, biking, mountain climbing and sky-diving, for example, camera manufacturers have recently come to develop, manufacture and market high-definition digital video electronic camera/camcorders, often used in these action video photographic instances. Compact, lightweight, rugged and simple to operate, camera/camcorders of this sort have been made available to capture still photos or video through a wide-angle lens, with accessories to mount to a helmet, to a bumper or to a windshield of a vehicle. Various wearable or mountable manners have also been developed to facilitate self-capture experiences different from those previously attainable with traditional cameras and smartphones.

Recognizing that the use of these camera/camcorders would also offer unique photographic perspectives in such activities as surfing, snorkeling, spear fishing, kayaking, white water rafting, and scuba-diving, protective cases claiming a waterproof capability have been proposed to enclose these video systems for use in such environmental activities—or even just for wet-weather photographing in general.

As will be appreciated, such digital video electronic camera/camcorders, whether designed for air and land—and for underwater use in accordance with further developments—are not inexpensive. Costing several hundreds of dollars, and even more, their availability to wise sectors of the populous becomes increasingly limited as the sophistication of the digital systems become greater. But, as it has been recognized that shoes are rentable at bowling alleys, that skates are rentable at ice and roller rinks, that skis and boots are rentable at the slopes and that clubs are rentable at golf course pro shops, so too it is hoped that these protective waterproof cases and digital video electronic camera/camcorders will also become available for daily and weekly rentals—and not only for air and land use as in skating, skiing, hiking, biking, mountain climbing and sky-diving, but also in such wet-weather and underwater activities as surfing, snorkeling, spear fishing, kayaking, white water rafting, scuba diving and ski jumping.

### OBJECTS OF THE INVENTION

Appreciating that many of these activities are of a generally rough and tumble nature where a user's hands are not generally available to hold onto the protective case while performing the activity, or just where the activity itself is of a type to toss the user about (as when sky-diving, white water rafting and ski jumping, for example), it is an object of the present invention to provide for the securement of the protective case to the body of the user whether the electronic camera/camcorder within be used for photographing air, land, wet weather or underwater activities. And, as will also be understood, this need for securement becomes all the more necessary for notice users of the electronic camera/camcorder in its protective case—and especially for those utilizing the digital video electronic system within on a daily or weekly rental basis.

### BRIEF DESCRIPTION OF THE INVENTION

As will become clear from the following description, the protective case of the invention, for electronic camera/camcorders for air, land and underwater use employs first, a manner of securing the protective case about the neck are of the user, and second, (for the more vigorous activities), a manner of securement about the body of the user. While either proves advantageous in and of itself, a combination of the two together will be acknowledged as providing the most beneficial result. And, as will be understood, the teachings of the invention will be seen applicable not only where the protective case of the invention is useful in an underwater usage, its employment will be seen useful if only joined with protective cases intended just for air and land recording instead.

### BRIEF DESCRIPTION OF THE DRAWINGS

These and other features of the invention will be more clearly understood from a consideration of the following description, taken in connection with the accompanying Drawings in which:

FIGS. 1a-1g are 7 views of a prior art protective case for a digital video electronic camera/camcorder helpful in an understanding of the invention—with FIG. 1a being a front elevation view of the protective waterproof case, FIG. 1b being a top plan view thereof, FIG. 1c being a bottom plan view thereof, FIG. 1d being a right side elevation view, FIG. 1e being a left side elevation view, FIG. 1f being a rear elevation view, and FIG. 1g being a rear perspective view of the protective waterproof case;

FIGS. 2a-2g are 7 views of a modified protective case for the digital video electronic camera/camcorder also employing, however, an On-Off light source for low light level illumination conditions—along with an additional adaptor more particularly shown in FIG. 3;

FIG. 3 illustrates the adaptor useful in adding to the FIGS. 2a-2g version of the protective case that feature of the invention which enables securement of the protective case about the neck of a user;

FIGS. 4a-4g are 7 views respectively comparable to those of FIGS. 2a-2g, but modified therefore to illustrate securement of the protective case about the body of a user in accordance with the teachings of the present invention; and

FIG. 5 illustrates a latch member helpful in understanding the securement of the case about an arm, leg or chest of the wearer.

### DETAILED DESCRIPTION OF THE INVENTION

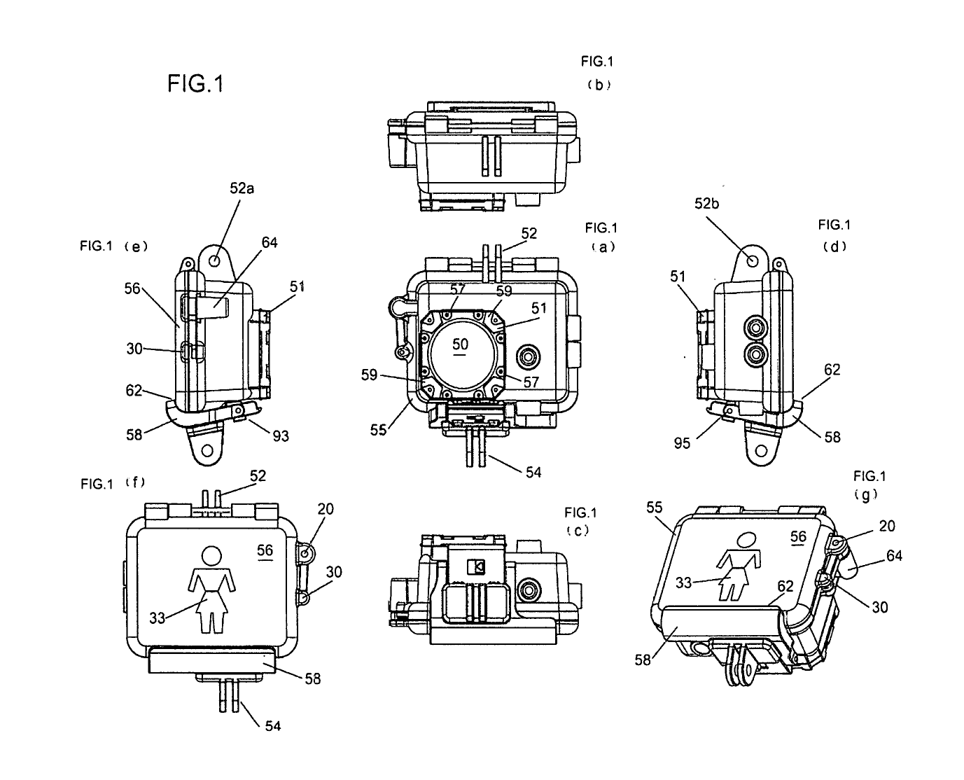

While the views of FIGS. 1a-1g together illustrate a prior art protective case for electronic camera/camcorders for air, land and underwater use, the teachings of this invention apply in like manner to those protective cases where only air and land usage is envisioned. (In accordance with a concurrently filed Application of mine [Non-Provisional application Ser. No. ______, based on Provisional Application Ser. No. 62/188,779], the general difference between an air and land use protective case and one intended additionally for underwater and wet weather usage is the inclusion of the latter of an audio port [as represented in the views of FIGS. 1a-1g below] to allow sound from an outside environment to reach the built in microphone incorporated in the digital video electronic camera/camcorders.) With this understanding, reference numerals 50 and 51 respectively identify a clear lens cover and a surrounding lens cover frame incorporated within a front surface of the prior art case 55, reference numerals 52 and 54 represent pillar receptors to couple to various mounts and accessories for the case and for the digital video electronic camera/camcorder enclosed within, and reference numeral 56 represents a transparent back cover. Reference numeral 58 represents a latch member to lock and hold the back cover 56 closed, with its lip 62 bendable outward to allow the back cover 56 to be opened and closed. Reference numeral 64 represents a cup of an audio port for passing sound into the compartment which encloses the electronic camera/camcorder. In accordance with my above concurrently filed application Ser. No. ______, the audio port may be closed by inserting the plug of a sealing device into the cup for underwater use where sound input is not generally relevant in a recording, or opened by withdrawing the plug to allow desired sound pressure waves from an external environment to penetrate through the port for air and land use recording; in a second version described therein, the audio port cup itself may include a waterproof acoustic membrane within, and spanned across, the cup to allow the passage of sound to the electronic camera/camcorder microphone input (but not water) in the event the sealing device plug is forgotten to be inserted in advance of a water environment type usage.

As will be appreciated, in accordance with the present invention, a lanyard can be inserted through apertures 52a and 52b provided in each of the pillar receptors 52 as illustrated in the side elevation views of FIGS. 1d and 1e. This allows a tying of the protective case around the neck of a user. This will assist in just holding the protective case, and also in securing and stabilizing it is position.

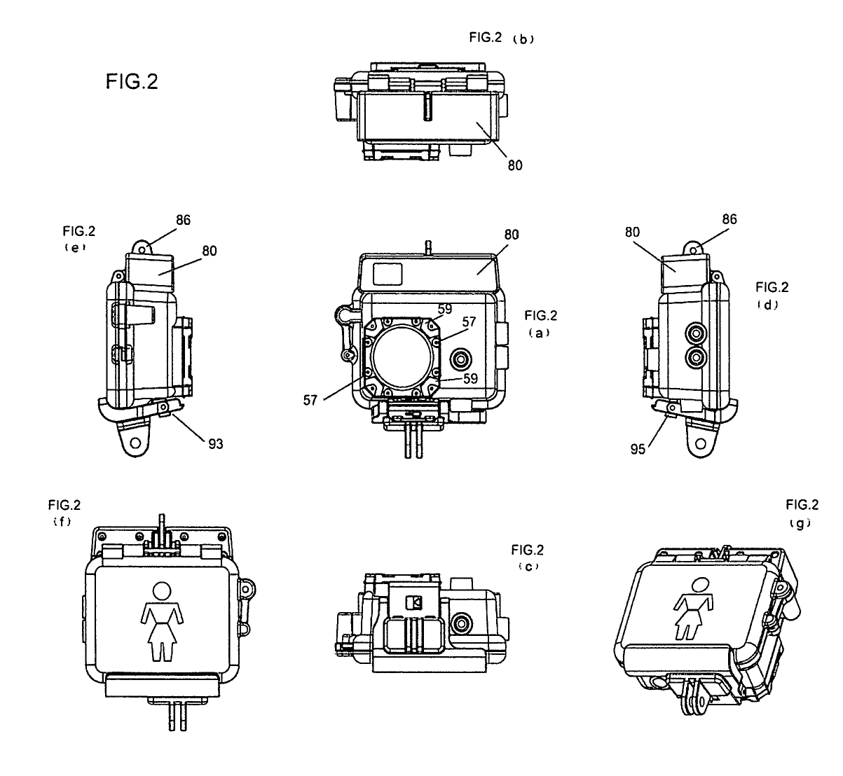

The clear lens cover 50 and surrounding lens cover frame 51 of the FIG. 1 prior art views are repeated in the front elevation view of FIG. 2a, the top plan view of FIG. 2b, the bottom plan view of FIG. 2c, the right side elevation view of FIG. 2d, the left side elevation view of FIG. 2e, the rear elevation view of FIG. 2f and the rear perspective view of FIG. 2g. Taking these views together, the clear lens cover 50 is secured within the lens cover frame 51 on the front surface of the protective case by means of the fasteners 57, with the lens cover frame 51 then being secured to the case by prong fasteners 59—as illustrated in FIG. 1a. As will be understood, any scratching or other damage caused to the clear lens cover 50 requiring its replacement would thus necessitate the freeing of the 4 frame prong fasteners 59 and then the 8 lens cover fasteners 57 to remove and replace the clear lens cover 50 (or just the 4 frame prong fasteners 59 if the lens cover frame and clear lens cover were both to be discarded).

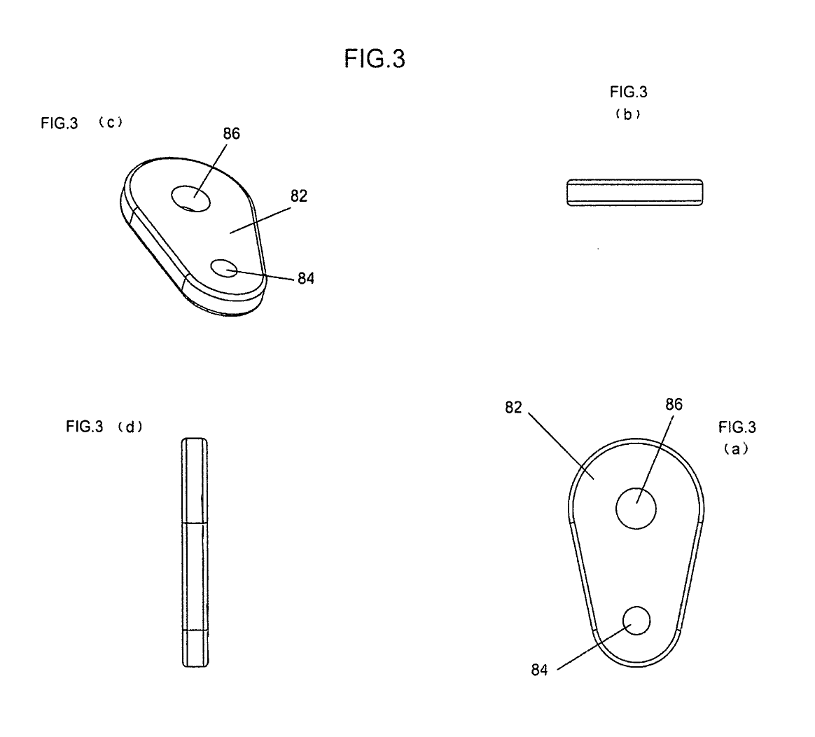

The views of FIGS. 2a-2g replicate those of FIGS. 1a-1g, but with the addition of an On-Off light source 80 mounted on the pillar receptors 52 (FIGS. 2a, 2b, 2d and 2e) for low light level illumination. To mount the light source 80 to the pillar receptors 52 and yet allow a lanyard to continue to be used in securing the protective case about the user's neck for use of the digital video electronic camera/camcorder in front of the body, an adaptor 82 is employed at a top surface of the protective case—illustrated by the views of FIG. 3, in which the front elevation view of the adaptor 82 is shown in FIG. 3a, its top plan view is shown in FIG. 3b, its front perspective view is shown in FIG. 3c and its left side elevation view is shown in FIG. 3d—a right side elevation view being a mirror image. As will be appreciated, fastening the adaptor 82 to the apertures 52a and 52b of the 2 pillars 52 via an adaptor aperture 84 in FIGS. 3a and 3c effectively extends the length of the adaptor above the light source 80 so that the connecting lanyard about the neck of the user can still be had, namely, through the aperture 86 in FIGS. 3a and 3c.

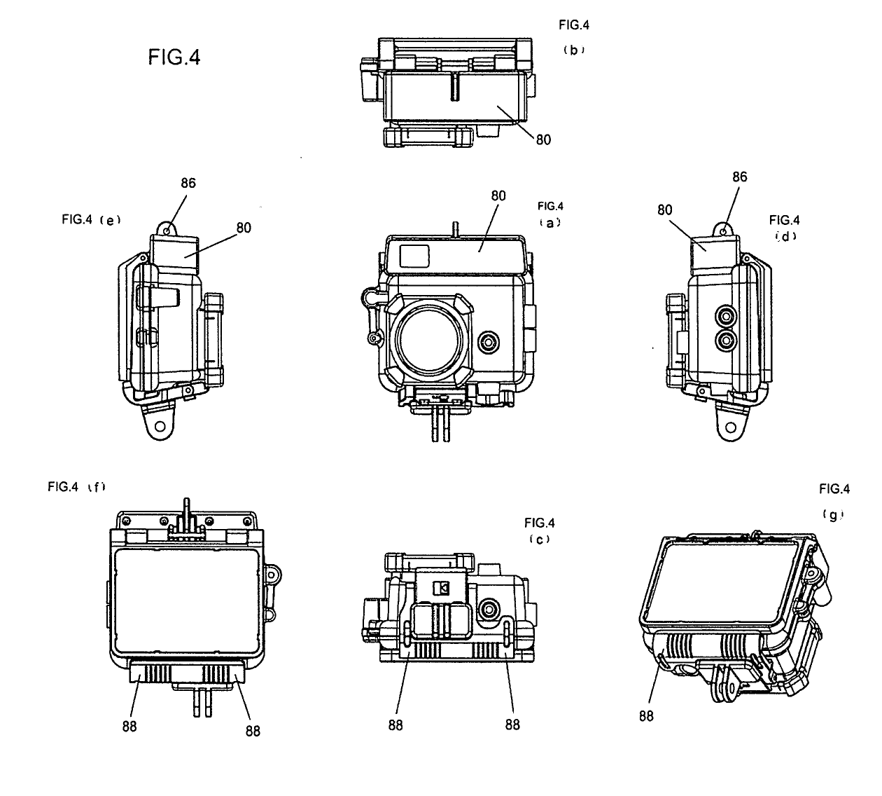

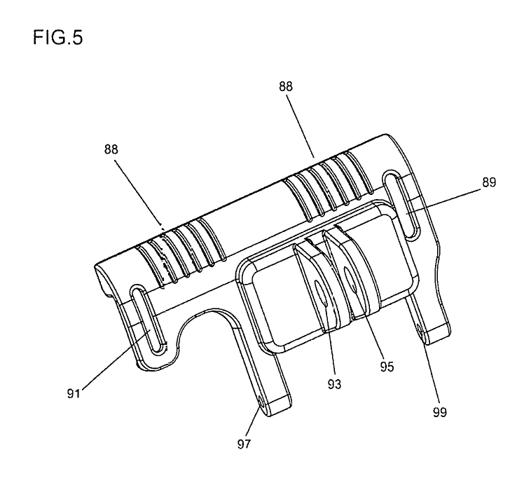

The views of FIGS. 4A-4g replicate those of FIGS. 1A-1g but with the addition of an optional ribbing at 88 on the latch member 58 for ease in opening and closing the back cover 56. More particularly shown in FIG. 5, the latch member 58 employs a further pair of apertures 89, 91 separate from those shown as 93, 95 for the pillar receptors 54 (FIGS. 1a, 1f). These apertures 89, 91 are sized to accept a webbing passing through to enable the protective case to be encircled around the arm, leg or other area of the body to secure the protective case there during video recording, instead of just having a lanyard tie about the neck. As will be appreciated, this allows an additional unique recording of environmental scenes from a different angle or perspective than is normally obtainable with a digital video camera mounting to handle bars, bumpers or headsets—or just being held in front. Its usefulness will be apparent in such instances as where one electronic camera/camcorder is being mounted on a helmet, at the same time that a second electronic camera/camcorder is secured about a leg of the user—in a tract meet competition, for example, or while sky-diving. The apertures 97, 99, in this respect, allow for receipt of fasteners to hinge the latch member 58 in opening and closing the back cover 56. And as will be appreciated, the logo 33 on FIGS. 1 and 2 are just representative of a display on the electronic camera/camcorder screen.

While what have been described are considered to be preferred embodiments of the present invention, it will be readily appreciated by those skilled in the art that modifications can be made without departing from the scope of the teachings herein. For at least such reason, therefore, resort should be had to the appended claims for a true understanding of the invention.

I claim:

1. In combination with a digital video electronic camera/camcorder enclosed within a protective case, the apparatus comprising:
means incorporated with said protective case for securing said digital video electronic camera/camcorder and said protective case about at least one of the neck and body area of a user thereof.

2. The apparatus of claim 1 wherein said means is incorporated with a top surface of said protective case.

3. The apparatus of claim 1 wherein said means is incorporated within a latch lock member for a back cover of said protective case.

4. The apparatus of claim 1 wherein said means is incorporated with both a top surface of said protective case and within a latch lock member for closing a back cover of said protective case.

5. The apparatus of claim 2 wherein said means includes a lanyard coupled to pillars extending from said top surface of said protective case.

6. The apparatus of claim 3 wherein said means includes a webbing extending between apertures on said latch lock member.
